(19) United States
(12) Patent Application Publication
(10) Pub. No.: US 2010/0219977 A1
(43) Pub. Date: Sep. 2, 2010

(54) MULTIPLE TRANSMITTER REMOTE CONTROL SYSTEM

(75) Inventors: William B. Pittard, Los Angeles, CA (US); Duncan Wain, Palos Verdes Estates, CA (US); Scott Cernetic, Big Bear Lake, CA (US)

Correspondence Address: DARBY & DARBY P.C., P.O. BOX 770, Church Street Station, New York, NY, 10008-0770, US

(73) Assignee: Scenewise, Inc., El Segundo, CA (US)

(21) Appl. No.: 12/717,857

(22) Filed: Mar. 4, 2010

Related U.S. Application Data
(63) Continuation-in-part of application No. 10/597,528, filed on Sep. 28, 2006, now Pat. No. 7,705,746.
Application No. 10/597,528 is a continuation of application No. 11/576,975, filed on Oct. 26, 2007.
(60) Provisional application No. 60/541,466, filed on Feb. 2, 2004.
(60) Provisional application No. 60/618,191, filed on Oct. 12, 2004.

(51) Int. Cl. G05B 19/02; G08C 19/00

(52) U.S. Cl. 340/825.22; 340/825.69

(57) ABSTRACT

A remote control system includes multiple transmitters located at differing positions around a housing. The transmitters are spaced apart so that a transmission from one of the transmitters is likely to be received even if a transmission from another transmitters is obstructed or oriented away from a receiver. One embodiment comprises a simplified remote control with infrared transmitters located on multiple surfaces. A controlled device may require at least one transmitter to be approximately aligned with a receiver and/or may require an unobstructed signal path. If a user, such as a child, covers some of the transmitters and/or holds the remote control in an unusual orientation, a signal can still be transmitted to a DVD player, DVR, computer or other controlled device. The signal may comprise a key code identifying an activated remote control key, and instructing the controlled device to perform a navigation, a direct select, or other operation.

### CROSS-REFERENCE TO RELATED APPLICATIONS

This application is a Continuation-in-Part of U.S. patent application Ser. No. 10/597,528, filed on Sep. 28, 2006, which is a National Stage of International Patent Application PCT/US2005/002843, filed Feb. 1, 2005, which claims the benefit under 35 USC 119(e) of U.S. Provisional Patent Application No. 60/541,466, filed Feb. 2, 2004, and this application is also a Continuation of U.S. patent application Ser. No. 11/576,975, filed Oct. 26, 2007, which is a National Stage of PCT/US2005/036733, filed Oct. 11, 2005, which claims the benefit under 35 USC 119(e) of U.S. Provisional Patent Application No. 60/618,191, filed Oct. 12, 2004, contents of all of which are hereby incorporated by reference.

### FIELD OF ART

The present invention relates generally to a remote control system, and more particularly to a remote control with multiple transmitters located at differing positions around the remote control to ensure that a signal is not blocked or misaligned from a receiver.

### BACKGROUND

Remote control devices, such as those used to control televisions, DVD players, audio equipment, and the like, typically include a single infrared transmitter. The transmitter is generally located at a front of the remote control device so that the transmitter can be pointed at an infrared receiver when the remote control device is held by a user or resting on a surface. Such remote control devices are normally designed to be held or otherwise operated so that the user's hands do not block the transmitter.

### BRIEF DESCRIPTION OF THE DRAWINGS

FIG. 1 is a front view of a multiple transmitter remote control according to one embodiment of the invention;

FIG. 2 is a top view of the multiple transmitter remote control according to one embodiment of the invention;

FIG. 3 is a bottom view of the multiple transmitter remote control according to one embodiment of the invention; and

FIG. 4 is a functional block diagram of the multiple transmitter remote control according to one embodiment of the invention;

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as devices or methods. Accordingly, the present invention may take the form of an entirely hardware embodiment or an embodiment combining software and hardware aspects. The following detailed description is, therefore, not to be taken in a limiting sense.

### Illustrative Remote Control Device

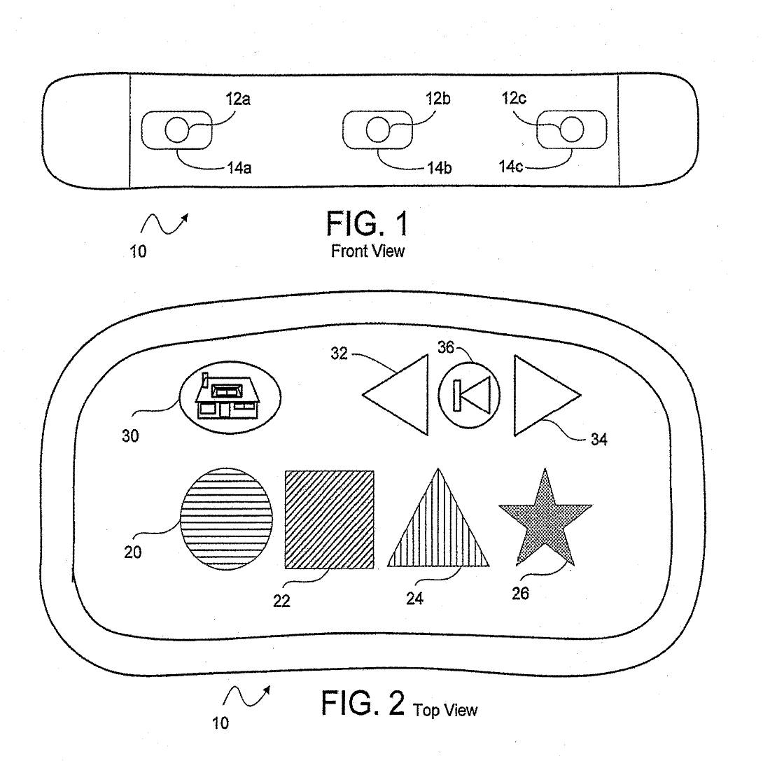

FIG. 1 is a front view of a multiple transmitter remote control 10 according to one embodiment of the invention. Remote control 10 includes multiple transmitters 12a-12c and corresponding covers 14a-14c that are spaced apart from each other such that at least one transmitter is likely to be exposed if the other transmitters are obstructed by a user's hand(s) and/or other item. The transmitters can comprise infrared, radio frequency, and/or other types of transmitters. Each transmitter can also be located at differing positions around the perimeter of the remote control so that at least one transmitter can be aligned with a receiver when the remote control is rotated. Each transmitter can also be oriented in different directions to improve alignment with the receiver as the remote control is moved relative to the receiver. In addition to the positions shown, transmitters can be located on upper, lower, and/or other surfaces of the remote control.

FIG. 2 is a top view of multiple transmitter remote control 10 according to one embodiment of the invention. Remote control 10 includes any number of keys to activate predefined and/or programmable operations. The invention can be applied to any remote control device that can control any of a variety of electronic devices, such as DVD players, audio equipment, computing devices, lights, machines, and the like. This includes remote control devices that use conventional keys and corresponding dedicated and programmable operations. However, the invention can also be applied to specialized remote control devices. Remote control 10 is one example of, but not limited to, a specialized remote control device with a simplified set of keys that can be used by a child to interact with software and media content that conforms to an industry standard

DVD-Video specification. To interact with software controlled media content, a number of keys, referred to as direct-select keys 20-26, can be dynamically associated with operations that change throughout the course of a DVD program. For example, each key shape and/or color can be associated with a similarly shaped and/or colored icon in a display to enable a user to select from a plurality of operations programmed into DVD media content. In addition, a number of navigation keys 30-36 can be programmed to navigate through the DVD media content in a consistent manner with any make or model of DVD player. Dedicated navigation functions provided by DVD players often perform differently, depending on the make and model of the DVD player. To avoid inconsistent performance, remote control 10 can use programmable number key codes for the navigation operations as well as the direct-select operations. Software provided on a DVD disc enables the DVD player to interpret a received number key code as a command to perform a consistent navigation operation or another operation that is currently associated with a selected key.

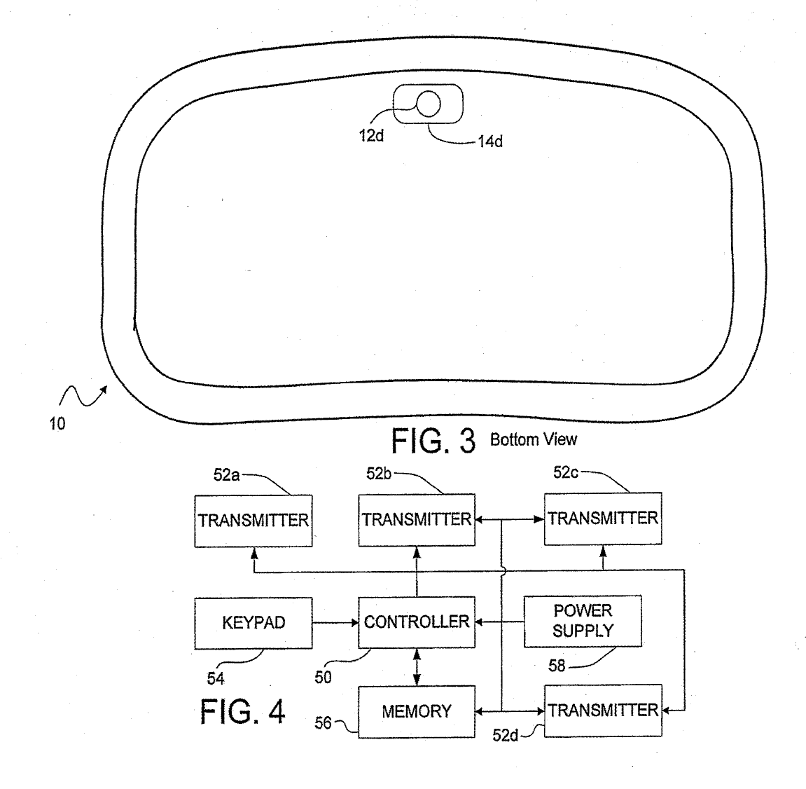

In any case, depressing any of the keys causes each transmitter to transmit a key code to a receiver. If a user, such as a child, has covered a transmitter, other transmitters can still communicate the key code to the receiver. Similarly, if the user holds the remote control vertically or at another angle, rather than horizontally, a bottom transmitter can still communicate the key code to the receiver. For example, FIG. 3 is a bottom view of multiple transmitter remote control 10 showing a transmitter 12d and cover 14d on a bottom surface of remote control 10. One or more such transmitters may be positioned and/or oriented to improve transmission to the receiver. For instance, transmitter 12d may be oriented at a forty-five degree angle toward the front of the remote control. The duration of the signal transmission can also be extended to ensure that a receiving electronic device receives the signal. If the receiving electronic device detects signals for only a predefined period, software can be used to ensure that an extended signal is not interpreted as multiple commands.

### Illustrative Remote Control Environment

FIG. 4 shows a functional block diagram of an exemplary remote control, according to one embodiment of the invention. The remote control may include many more or fewer components than those shown. The components shown, however, are sufficient to disclose an illustrative embodiment for practicing the invention. The remote control includes a controller 50 coordinates remote control processes. Controller 50 is in communication with transmitters 52a-52d. The transmitters can be connected in serial or parallel, but are shown in parallel such that failure of one transmitter will not affect the remaining transmitters. Controller 50 is also in communication with a keypad 54, which can include multiple types of keys on multiple faces of the remote control. A memory 56 provides permanent and temporary data storage for controller 50. A power supply 58, such as a battery, provides power to other components of the remote control.

The above components can be arranged within any desired housing. For example, other embodiments include a circular disk, spherical, cube, or other housing shape with transmitters located at multiple positions around the perimeter of the remote control. Keys and transmitters can be located on multiple faces of the remote control, so that the remote control can be used at any orientation. A raised ridge around edges or the circumference of the remote control can prevent activation of keys that are currently adjacent to a floor, table, or other surface.

The above specification, examples and data provide a complete description of the manufacture and use of the composition of the invention, although many other embodiments are possible. For example, the remote control device can be adapted to control access to markup language content through a network. The remote control device could be used in place of a keyboard and/or mouse, for easier use by children, seniors, and/or disabled users. Since many embodiments of the invention can be made without departing from the spirit and scope of the invention, the invention resides in the claims hereinafter appended.

What is claimed as new and desired to be protected by Letters Patent is:

1. A remote control system comprising:
a housing;
at least one key coupled to the housing; and
a plurality of transmitters that each transmit a signal upon activation of the at least one key and that are located at differing positions around the housing with a spacing that provides a transmission to a receiver of a controlled device in the event that another transmission is one of the following; obstructed and oriented away from the receiver.

2. The remote control system of claim 1, wherein at least one of the plurality of transmitters transmits in a differing direction from another one of the plurality of transmitters.

3. The remote control system of claim 1, wherein the plurality of transmitters are located about multiple surfaces of the housing.

4. The remote control system of claim 1, wherein the housing forms one of a rectangular shape, a disk shape, a spherical shape, and a cube shape.

5. The remote control system of claim 1, wherein activation of the at least one key causes the plurality of transmitters to transmit a key code associated with an activated key.

6. The remote control system of claim 5, wherein the key code is associated with an instruction to the controlled device to perform a programmed operation.

7. The remote control system of claim 6, wherein the programmed operation comprises one of the following; a navigation operation and a direct select operation.

8. The remote control system of claim 1, wherein the at least one key is associated with an icon displayed on a display coupled to the controlled device, wherein the icon is dynamically associated with operations that change throughout the course of an interactive program.

9. The remote control system of claim 1, further comprising at least one cover over the plurality of transmitters, wherein the at least one cover does not interfere with transmission of the signal to the receiver.

10. The remote control system of claim 1, wherein the plurality of transmitters comprise one of the following; a plurality of infrared transmitters and a plurality of radio frequency transmitters.

11. The remote control system of claim 1, wherein the signal conforms to a digital versatile disc (DVD) video specification.

12. A method for transmitting a signal to a receiver, comprising:
detecting activation of a key coupled to a housing of a remote control device;
causing a plurality of transmitters in communication with the key to transmit the signal, wherein the plurality of transmitters are located at differing positions around the housing with a spacing that provides a transmission to a receiver of a controlled device from one of the plurality of transmitters in the event that another transmission from another one of the plurality of transmitters is one of the following; obstructed and oriented away from the receiver.

13. The method of claim 12, further causing at least one of the plurality of transmitters to transmit in a differing direction from another one of the plurality of transmitters.

14. The method of claim 12, further causing each of the plurality of transmitters to transmit from a different surface of the housing.

15. The method of claim 12, wherein the signal communicates a key code associated with the activated key.

16. The method of claim 15, wherein the key code is associated with an instruction to the controlled device to perform a programmed operation.

17. The method of claim 16, wherein the programmed operation comprises one of the following; a navigation operation and a direct select operation.

18. The method of claim 12, wherein the activated key is associated with an icon displayed on a display coupled to the controlled device, wherein the icon is dynamically associated with operations that change throughout the course of an interactive program.

19. The method of claim 12, wherein the signal comprises one of the following; an infrared signal and a radio frequency signal.

20. A machine readable medium storing data and instructions that cause the remote control device to perform the operations of claim 12.
